(19) United States
(12) Patent Application Publication
(10) Pub. No.: US 2003/0140015 A1
(43) Pub. Date: Jul. 24, 2003

(54) Counter-terror envelope

(76) Inventor: Michael Applebaum, Cook County, IL (US)

Correspondence Address: Michael Applebaum, P.O. Box 11376, CHICAGO, IL, 60611-0376, US

(21) Appl. No.: 10/280,840

(22) Filed: Oct. 26, 2002

Related U.S. Application Data
(60) Provisional application No. 60/340,687, filed on Oct. 30, 2001.

(51) Int. Cl. G06F 17/00; B65D 27/32; G07B 17/02

(52) U.S. Cl. 705/406; 229/307

(57) ABSTRACT

A method and apparatus for preventing terror through the use of a delivery container are provided. The envelope (20) comprises a front portion (22) and a rear portion (24) defining therebetween a space (76) for receiving contents, and one or a plurality fenestrations (56). None, one or a plurality of the fenestrations may have a cover (58). Substances smaller than the fenestration either exit the envelope (20) prior to delivery and/or accumulate in the cover (58) making them detectable prior to opening the envelope (20).

### BACKGROUND

1. Field of Invention

This invention relates to containers, especially to delivery containers, such as envelopes, that are used to combat terrorism and protect the safety of the public.

1. Description of the Prior Art

Where used, a term in the plural form is meant to include both the singular and plural. Where used, a term in the singular form is meant to include both the singular and plural. Where used, a gender specific word is meant to include one or both genders.

Envelopes are a common and well-known means for transporting materials between parties. Envelopes may be used to transport materials via the domestic mail, foreign mail, international mail, courier services, business mailrooms, and interoffice mail, to name a few.

Until recently, there was an expectation that the contents of an envelope were neither potentially harmful nor potentially fatal.

For all practical purposes, the United States and other countries did not have to deal with the issue of direct terror in envelopes until September/October 2001. Events following the destruction of the World Trade Center's Twin Towers included anthrax spores in powdered form sent and delivered via the United States Postal Service to recipients in the media and government. Including handlers, recipients and those in relative proximity to them, thousands were exposed, many sickened, some died.

Terrorists and the U.S. Government have publicly stated that this is just the beginning.

The nature of this substance, and other hazardous substances, is that of a powdery material that upon opening of the envelope in which it is contained, either contacts and infects the skin or aerosolizes and enters the lungs.

It is the structural integrity and/or the opacity of the container, in this case an envelope, which allowed the terrorists to successfully deliver their hazardous, harmful, injurious, destructive, disruptive, terror-causing, disease-causing and/or deadly matter.

To prevent this and other such substances from successful delivery it is necessary to:

a. purposefully breach the integrity of the container thus preventing the envelope from containing the substance or substances, and/or

b. interrupt its opacity in locations that would allow for warning of the presence or possible presence or the detection of contained substances prior to opening the envelope, and/or

c. a combination of the above.

There are no previous inventions that have dealt with the problem of terrorism and a solution via a counter-terror container, in particular an envelope. No prior art exists for such a container that allows passage of contents, inspection of contents, and/or testing of contents by either human or nonhuman (e.g., mechanical, chemical, biological, etc.) means for purposes of protection from terror, and the restoration of confidence in the public. And, specifically, as relates to the preferred embodiment of my anti-terror envelope, there is no prior art disclosing an envelope one of whose purposes is to lose all or some of its contents prior to delivery.

In addition to the direct effects that harmful and/or potentially deadly substances may have on the recipient and/or handlers, there are indirect effects. For example, the public became less inclined to open the mailings from businesses offering discounts, new or improved product information, and specials for fear that the envelopes may contain harmful, and/or a deadly substances. Some results of this are decreased consumer spending, loss of jobs, loss of revenue, and slowing of progress by cutbacks in research and development. Another example of an indirect consequence is that those in relative proximity to the handlers and/or recipient are at risk as shown many times in the attacks that have already occurred.

In the prior art, there are instances of fenestrated envelopes. However, the purpose and location of these windows/openings/holes relate to addresses, advertising, promotional materials, and postage.

U.S. Pat. No. 868,804 to Peppler (1907) discloses a card-holding envelope that has a space cut away at the upper right hand corner so as to completely expose the stamp and a portion of a postcard, so that the cancellation of the stamp and the postmark on the card may be affixed thereto. This disclosure relates solely to a window for postage purposes and is limited to use in a mailing envelope.

U.S. Pat. No. 1,068,858 to Cohn (1913) discloses a window covered by a transparency in such fashion as to allow air to escape from the envelope so that the transparency will lie close against the enclosure and render the addressee's name and address to be easily read. This disclosure relates to the use of a covered window in the addressing of an envelope but not in identifying or examining its contents. It allows the escape of air, not material that is intentionally placed.

U.S. Pat. No. 1,343,075 to Benedict (1920) discloses an envelope by which the postage stamp will more effectively adhere to the envelope and by which air within the envelope may escape. There is no disclosure for use as a device to allow the discharge of intentionally placed hazardous, injurious, deadly, etc. materials.

U.S. Pat. No. 3,986,662 to Luftig (1976) discloses a mailing apparatus comprising an envelope including openings there and covered by glassine windows that permit viewing of the address and a number imprinted on the communication that has been appropriately folded and properly inserted into the envelope. This disclosure is for an invention having only covered windows and used for reading printed matter through the window.

U.S. Pat. No. 5,074,459 to O'Neill (1990) discloses a mailing envelope that has a business card size window cut in the upper left hand corner of the envelope where the return address normally appears. A clear sheet of plastic is folded and glued to form a pocket into which the business card is inserted so as to serve as a return address. In this disclosure a window is being used for purposes of an address

U.S. Pat. No. 6,029,883 to Hechinger, et al. (2000) discloses an envelope with a window that may or may not be covered but is located in such a position as to expose postage indicia applied to the material within the space. Although U.S. Pat. No. 6,029,883 is for an envelope containing a window that may or may not be covered, its use is for postage.

Of the several types of fenestrated envelopes comprised by the prior art, all suffer from one or more of the following disadvantages:

A. All prior art concerns envelopes whose purpose is to keep its intentionally placed contents inside until the envelope is opened.

B. Their use is generally limited to addresses, advertising, promotional material, and postage.

C. When used to identify contents, their use is limited to identifying the presence of information on specifically positioned printed matter.

D. There is no prior art one of whose purposes is to allow either the escape and/or identification of intentionally placed material prior to opening the envelope. The prior art addresses the escape of air, which is unintentionally placed.

E. There is no prior art regarding fenestrated envelopes one of whose purposes is to alert the recipient and/or the handlers as to the possibility that potentially harmful, hazardous, injurious, terror-causing, disease-causing, disruptive, destructive, and/or deadly substance and/or substances may be included within the container. (“Harmful, hazardous, injurious, terror-causing, disease-causing, disruptive, destructive, and/or deadly substance and/or substances” will heretofore be referred to as “objectionable materials.” The term “objectionable materials” is intended to refer to one or more of the aforementioned substances.)

F. There is no prior art that alerts the handlers and/or recipient of mail as to the presence or possible presence of objectionable materials within an envelope allowing an opportunity for the handlers and/or recipient to take precautions and/or notify appropriate authorities prior to opening the container.

G. There is no prior art regarding fenestrated envelopes one of whose purposes is to protect the recipient, handlers, and those in relative proximity to them from harm, injury, etc. from objectionable materials that may be included within an envelope.

H. There is no prior art regarding fenestrated envelopes one of whose purposes is to protect a central distribution location and those present from objectionable materials.

I. There is no prior art allowing for the identification, characterization, testing, etc. of actual or potentially objectionable materials and/or substances, by either human and/or non-human (e.g. mechanical, chemical, biological, etc.) means, within an envelope prior to opening it.

J. There is no prior art allowing for the identification, characterization, testing, etc. of actual or potentially objectionable materials and/or substances, by either human and/or non-human (e.g. mechanical, chemical, biological, etc.) means, within an envelope prior to its reaching a central distribution area.

K. None of the prior art addresses the use of a fenestrated envelope to deter, stymie, frustrate, foil, and prevent the sending of actual or potentially objectionable materials within envelopes.

L. None of the prior art prevents someone from intentionally including objectionable materials in certain configurations within an envelope.

M. There is no prior art that by using an envelope removes a method of mischief from a terrorist or other troublemaker (e.g., hoaxer, prankster, etc.).

N. There are no instances of prior art where one or a plurality of fenestrations is purposefully placed in an envelope for use as a counter-terror device.

O. None of the prior art can function to improve the efficacy, increase the efficiency and decrease the cost of other terrorism prevention strategies, such as irradiating, sterilizing, neutralizing, etc. mail.

P. None of the prior art can function as a back-up, fail-safe, adjunct, etc. to other terrorism prevention strategies, such as irradiating, sterilizing, neutralizing, etc. mail should such prevention strategies fail.

Q. None of the prior art makes sabotage to the envelope apparent.

R. There is no prior art for any delivery container whose purpose is to lose some or all of its contents prior to delivery.

### SUMMARY

In accordance with the present invention, a delivery container comprising an exit means whereby all or some of its contents can either pass from the container to the outside and/or into one or a plurality of materials covering a predetermined portion of the exit means for detection and/or evaluation.

Objects and Advantages

Accordingly, several objects and advantages of my invention are:

a. to provide a delivery container, an envelope in the preferred embodiment, that allows substances smaller than the exit means, fenestration or fenestrations in the preferred embodiment, to fall through thereby exiting the container;

b. to provide an envelope that prevents and/or deters the container from being used as an effective device to deliver objectionable materials by allowing substances smaller than the fenestration or fenestrations to fall through thereby exiting the container;

c. to provide an envelope that allows substances smaller than the fenestration or fenestrations to fall through the container thereby lessening the amount of substance or substances available to cause harm;

d. to provide an envelope that prevents and/or deters the container from being used as an effective device to deliver objectionable materials by allowing substances smaller than the fenestration or fenestrations to fall through thereby lessening the amount of substance or substances available to cause harm

e. to provide a container that protects the handler and/or handlers of envelope(s), the recipient and/or recipients of envelope(s), and those in relative proximity to them from harm, hazard, injury, disruption, destruction, and/or death that can be caused by a substance or substances intentionally placed in envelopes;

f. to provide an envelope that allows inspection and/or evaluation of the interior of the container and/or its contents, visually or otherwise, by human or non-human (e.g., mechanical, chemical, biological, etc.) means to:

1) determine if objectionable materials are or may be or may have been present prior to opening the container;

2) warn the recipient and/or handlers of the container if objectionable materials are or may be or may have been present prior to opening the container;

3) caution the handlers and/or recipient to the presence of sabotage prior to opening the container;

4) allow the recipient and/or handlers of the container the opportunity to contact the authorities or others prior to opening the container;

5) allow the recipient and/or handlers of the container the opportunity to take the necessary precautions prior to opening the container;

6) characterize, identify, determine, etc. the nature of the contents of the envelope prior to opening the container; and

7) determine whether the contents of the envelope have been configured (e.g. folded, taped) in such manner as to prevent contained substances from falling out of the container or into a covered fenestration prior to opening the container.

g. to provide an envelope that deters and/or prevents a terrorist and/or other troublemaker from:

1) using an envelope as a means to cause harm, hazard, injury, disruption, destruction, and/or death;

2) using the mails (e.g., domestic, foreign, interoffice, couriered, etc.) as a means to cause harm, hazard, injury, disruption, destruction, and/or death; and

3) using the mails (e.g., domestic, foreign, interoffice, couriered, etc.) as a means to cause harm, hazard, injury, disruption, destruction, and/or death and thereby remove or limit the options available to a terrorist or troublemaker.

h. to provide an envelope that deters and/or prevents a hoaxer from successfully committing his/her hoax and its consequences;

i. to provide a container and method for:

1) deterring, preventing, and/or stymieing attempts to send objectionable materials in envelopes;

2) warning the handlers and/or recipient of envelopes that objectionable materials are or may be or may have been present within an envelope prior to opening it;

3) cautioning the handlers and/or recipient of envelopes that, prior to opening it the envelope may have been sabotaged;

4) warning the handlers and/or recipient of envelopes that objectionable materials are or may be or may have been present within an envelope and provide them an opportunity to take precautions prior to opening it;

5) warning the handlers and/or recipient of envelopes that objectionable materials are or may be or may have been present within an envelope and provide them an opportunity to contact the authorities prior to opening it;

6) allowing the recipient and/or handlers to evaluate its contents for objectionable materials prior to opening an envelope;

7) making domestic mail, international mail, couriered mail, interoffice mail, other types of deliveries, etc. safer;

8) providing a generally improved method of increasing the safety of the domestic mail, international mail, couriered mail, interoffice mail, other types of deliveries, etc.;

9) providing a generally improved method of increasing the efficiency of the domestic mail, international mail, couriered mail, interoffice mail, other types of deliveries, etc.;

10) providing a generally improved method of evaluating the contents of a container for the presence of objectionable materials;

11) restoring the confidence of the public in the mails;

12) improving the “opening percentage” of mail sent by individuals and/or businesses;

13) removing a method of terror from a terrorist's or troublemaker's options;

14) deterring and/or preventing hoaxes and their consequences;

15) protecting the handler and/or handlers of envelope(s), the recipient and/or recipients of envelope(s), and those in relative proximity to them from harm, hazard, injury, disruption, destruction, and/or death that can be caused by a substance or substances intentionally placed in envelopes; and

16) improving the efficacy, increasing the efficiency and decreasing the cost of other terrorism prevention strategies.

It is an object of this invention that where a covering or coverings is/are present, such covering(s) may be designed to react with certain substances and through such reaction or reactions would detect, identify, characterize, etc. the contents prior to opening. A reactive covering as described above may be transparent, translucent, opaque, or complex (combining the features of transparency, translucency, and/or opacity in its different portions) either before or after it has reacted.

It is an object of this invention that where a covering or coverings is/are present, such covering(s) may be designed to react with certain substances and through such reaction or reactions it may be possible to detect, identify, characterize, etc. the environment in which it was contained. A reactive covering as described above may be transparent, translucent, opaque, or complex (combining the features of transparency, translucency and/or opacity in its different portions) either before or after it has reacted.

It is an object of this invention to contain tamper proofing.

It is a further object of the counter-terror envelope to provide a means for verifying whether the invention has been subjected to other counter-terror methods, such as heat sterilization, irradiation, etc.

It is an object of the present invention that a means of automatically identifying the counter-terror envelope by machine may be incorporated.

It is an object of the present invention that a means of identifying the counter-terror envelope for manual handling may be incorporated.

It is an additional object of the present invention that when used as a re-mailer, response kit and/or return mail kit, that such re-mailer, response kit and/or return mail kit may be either symmetrical or asymmetrical (an example of an asymmetrical format would be that the send direction's portion contains an uncovered fenestration and the return direction's portion contains a covered fenestration and an uncovered fenestration).

Further objects and advantages are to provide an envelope which can be used easily and conveniently, which is simple to use and inexpensive to manufacture.

It is an object of the counter-terror envelope to be used as either a one-way envelope or as part of a re-mailer, response kit or return mail kit.

It is an object of this invention to provide a method for “retro-fitting” currently available envelopes to function as the counter-terror envelope does in some or all embodiments.

It is an object of this invention to acknowledge ongoing developments by U.S. domestic, foreign, and international postal authorities in their attempts to streamline and simplify the process of mail processing and delivery through automation by allowing variation in the size, shape, number, structure, and location of the exit means, fenestration or fenestrations in the preferred embodiment, whether covered or uncovered.

The above, as well as other objects and advantages of the invention will become apparent from the following detailed description, reference being made to the accompanying drawings.

### DRAWING FIGURES

Description of Drawings

FIG. 1 is a frontal view of a reference drawing of an envelope.

FIG. 2 is a frontal view of the preferred embodiment of my invention

FIG. 3 is a frontal view of a second embodiment of my invention

FIG. 4 is a frontal view of a third embodiment of my invention

FIG. 5 is a frontal view of a fourth embodiment of my invention

FIG. 6 is a frontal view of a fifth embodiment of my invention

FIG. 7 is a frontal view of a sixth embodiment of my invention

FIG. 8 is a frontal view of a seventh embodiment of my invention

FIG. 9 is a frontal view of a eighth embodiment of my invention

FIG. 10 is a frontal view of a ninth embodiment of my invention

FIG. 11 is a frontal view of a tenth embodiment of my invention

FIG. 12 is a frontal view of a eleventh embodiment of my invention

FIG. 13 is a frontal view of a twelfth embodiment of my invention

### LIST OF REFERENCE NUMERALS

20 envelope

22 front surface

24 rear surface

26 flap

28 upper edge

30 lower edge

32 left side edge

34 right side edge

36 left upper corner

38 right upper corner

40 left lower corner

42 right lower corner

44 front wall of fenestration

46 rear wall of fenestration

48 front surface of cover

50 rear surface of cover

52 back side of front surface of envelope

54 front side of rear surface of envelope

56 fenestration

58 cover

60 reinforcement

62 reinforcement material for front wall of fenestration

64 reinforcement material for rear wall of fenestration

66 perforation

68 thread

70 lower portion of flap

72 middle portion of flap

74 upper portion of flap

76 space

78 adhesive material

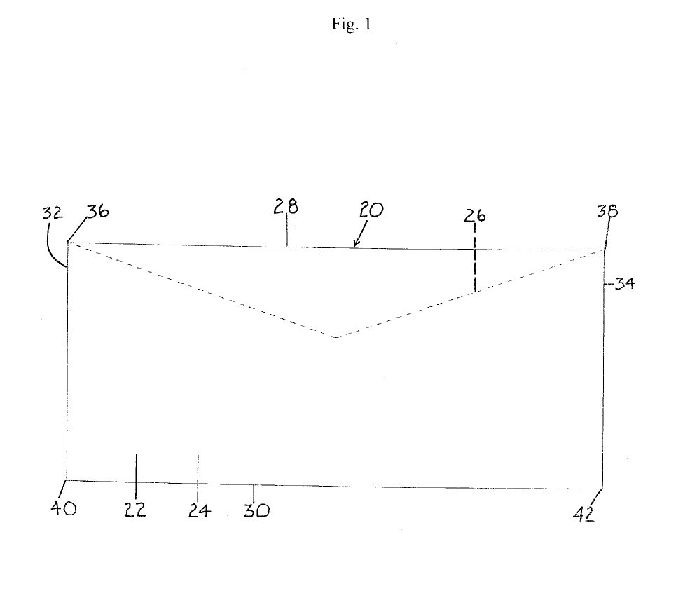

Description—FIG. 1—Reference Drawing of a Representative Envelope

A reference drawing of a representative mailing envelope has been included. In subsequent drawings, some parts of the envelope are intentionally missing. As reference to the expected location of the missing parts is made in subsequent drawings, this reference drawing has been included.

FIG. 1 is a frontal view of a representative envelope indicated generally by reference character 20. Envelope 20 comprises a front surface 22, a rear surface 24, an upper edge 28, a lower edge 30, a left side edge 32, a right side edge 34, a left upper corner 36, a right upper corner 38, a left lower corner 40, a right lower corner 42, and a flap 26 continuous with the front surface 22.

In all subsequent drawings, which show variations or embodiments of my invention, like numerals have been assigned to like elements of the invention for ease of reference.

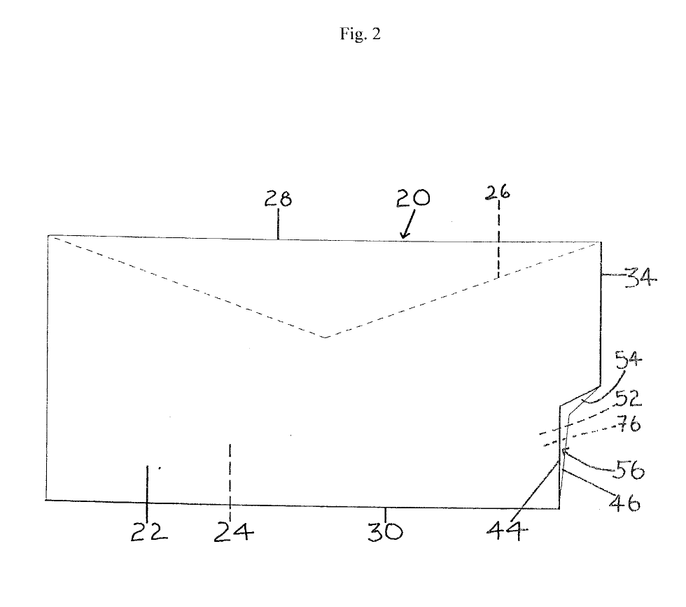

FIG. 2—Preferred Embodiment

FIG. 2 is a frontal view of the preferred embodiment of the container. A back side of front surface of envelope 52 and a front side of rear surface of envelope 54 define a space 76 between them, i.e., the interior of the envelope, for receiving contents.

A fenestration, window or aperture is indicated generally by reference character 56. Envelope 20 comprises a fenestration 56. A front wall of fenestration 44 and a rear wall of fenestration 46 are formed by the front surface 22 and rear surface 24, respectively. Fenestration 56 allows communication of space 76 with the outside. In the preferred embodiment, fenestration 56 appears in the expected locations of a right side of the lower edge 30, a lower portion of the right side edge 34, and the right lower corner 42 (not shown here but shown in FIG. 1).

In the preferred embodiment, envelope 20 is demonstrated as a mailing envelope. However, any type of envelope comprising front and back surfaces and one edge or a plurality of edges can be used. In the preferred embodiment a single fold forms an edge, however, envelopes with pleated sides, tops, bottoms, etc. can be used.

In the preferred embodiment, flap 26 can be opened to provide access to space 76 and closed to restrict access to space 76. Flap 26 is continuous with front surface 22. When contents have been placed within space 76, flap 26 may be affixed by appropriate means to rear surface 24 or closed by tucking into space 76.

In the preferred embodiment, flap 26 is continuous with front surface 22 and affixed to rear surface 24. However, any closure mechanism arising from and/or continuous with any portion of an envelope and/or extrinsic to an envelope (e.g., stapling, taping, etc.) can be used.

In the preferred embodiment, a single fenestration 56 is demonstrated. However, multiple fenestrations may be present.

In the preferred embodiment, fenestration 56 is located as described, however, a fenestration can be located anywhere in an envelope so long as the location of the fenestration can be oriented into a dependent position.

In the preferred embodiment, fenestration 56 has straight edges. However, the shape, size, type, number, appearance, location, purpose, etc. of a fenestration or fenestrations can be varied based upon the application or applications of a particular container. For example, a fenestration or fenestrations can range in size and shape from a slit, pinhole or pinholes to semi-circular and including a larger portion of a container.

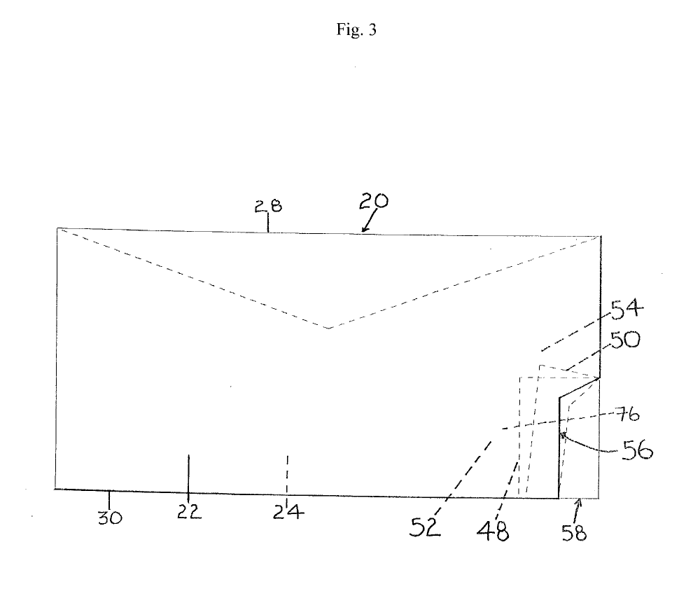

FIG. 3—Additional Embodiment

FIG. 3 is a frontal view of another embodiment of the container. A transparent covering covers fenestration 56. A fenestration cover, covering or wrapper is indicated generally by reference character 58. A front surface of cover 48 is applied to a back side of front surface of envelope 52 (an inner surface). A rear surface of cover 50 is applied to a front side of rear surface of envelope 54 (an inner surface).

In this embodiment, cover 58 is attached to envelope 20 on its inner surfaces 5254. The cover can be attached to one or both outer surfaces 22-24, to one or both inner surfaces 52-54, and/or to a combination of outer and inner surfaces 22-24 and 52-54, respectively.

In this embodiment, a single covered fenestration 56 is demonstrated. However, multiple covered fenestrations may be present in a particular envelope. So may a combination of one or a plurality of uncovered fenestrations and one or a plurality of covered fenestrations.

In this embodiment, cover 58 is transparent. However, a cover that is transparent, semi-transparent, translucent, opaque, or complex (having portions that are a combination of transparent, translucent, or opaque) may be present. A combination of the types of covers mentioned above may be present when an envelope comprises more than one covered fenestration.

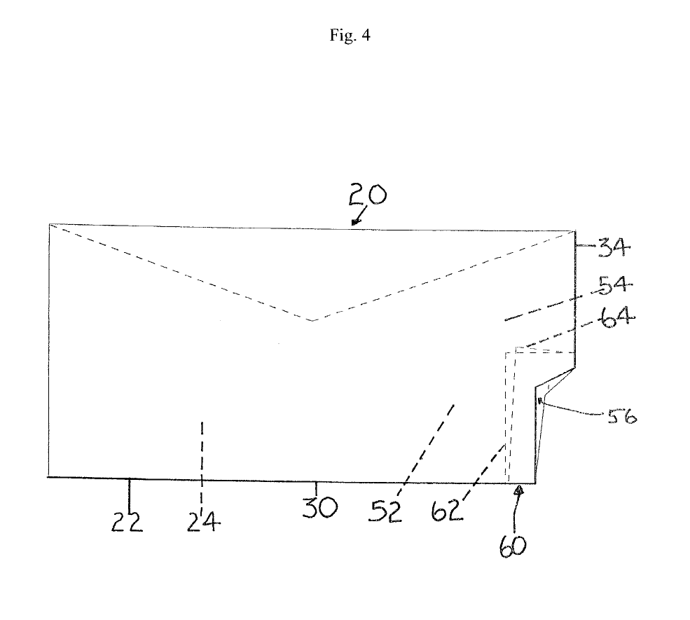

FIG. 4—Additional Embodiment

FIG. 4 is a frontal view of another embodiment of the container. A reinforcement of fenestration 56 is present. A reinforcement, support or bolster is indicated generally by reference character 60. Reinforcement 60 comprises a reinforcement material for front wall of fenestration 62 attached to the back side of front surface of envelope 52 and a reinforcement material for rear wall of fenestration 64 attached to the front side of rear surface of envelope 54. Reinforcement 60 is continuous around the margins of fenestration 56 at lower edge 30 and right side edge 34.

Reinforcement material may be of any type suitable to a purpose. Although this embodiment demonstrates a reinforced uncovered fenestration 56, covered and/or uncovered fenestration(s) may have reinforcement depending on such factors as size, shape, location, number, type, purpose, etc. Although this embodiment demonstrates reinforcement that is continuous around the margins of the fenestration 56, the lower edge 30 and right side edge 34, such a continuous reinforcement is not a requirement. The configuration of the reinforcement would depend upon such factors as the size, shape, location, number, purpose, etc. of the fenestration or fenestrations.

In this embodiment, reinforcement 60 is attached to envelope 20 on its inner surfaces 52-54. A reinforcement can be attached to one or both outer surfaces 22-24, to one or both inner surfaces 52-54 or to a combination of outer and inner surfaces 22-24 and 52-54, respectively.

A separate reinforcement may not be necessary as a fenestration cover may serve this purpose in some embodiments.

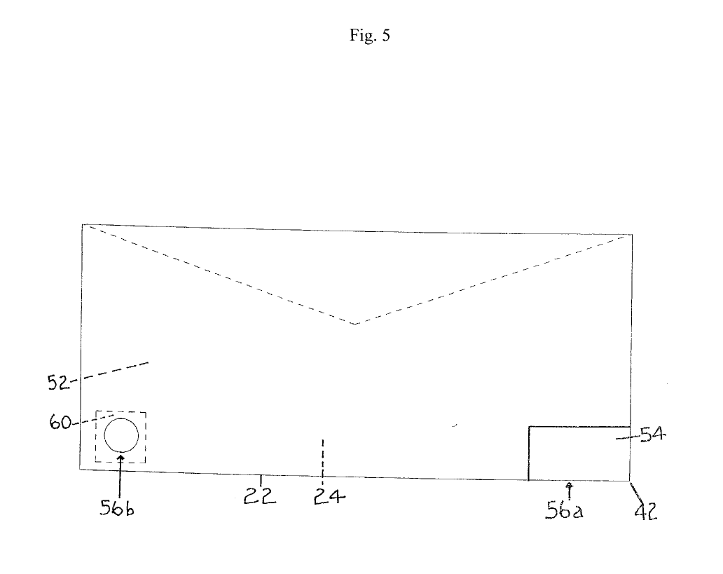

FIGS. 5-13—Additional Embodiments

FIG. 5 is a frontal view of another embodiment of the container. Fenestration 56a is located only in front surface 22 and extends to lower right corner 42. Rear surface 24 is not fenestrated. The front side of rear surface of envelope 54 is visible. A second fenestration 56b located only in front surface 22 is surrounded by reinforcement 60. Reinforcement 60 is attached to the back side of front surface of envelope 52. However, the location, size, shape, number, type, etc. of the fenestrations, whether reinforced or unreinforced need not conform strictly to this embodiment.

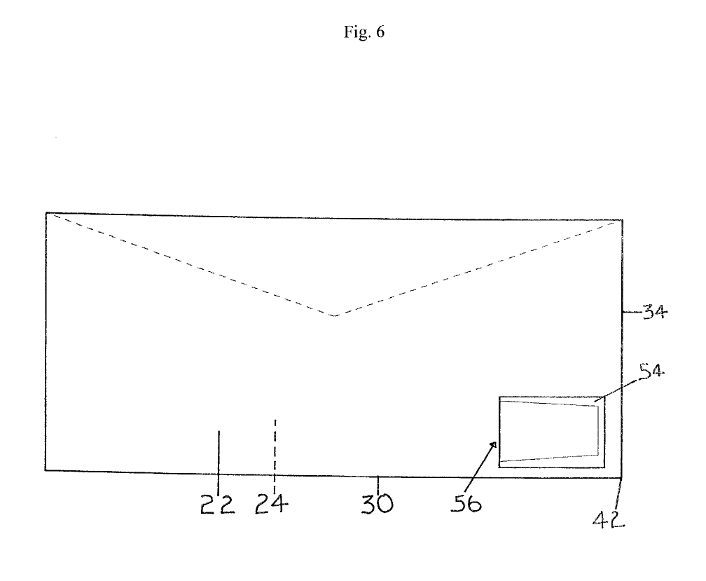

FIG. 6 is a frontal view of another embodiment of the container. It demonstrates the invention with a fenestration 56 that is located on both the front surface 22 and rear surface 24, near to but not including the lower edge 30, the right side edge 34 and the right lower corner 42. The front side of rear surface of envelope 54 is visible.

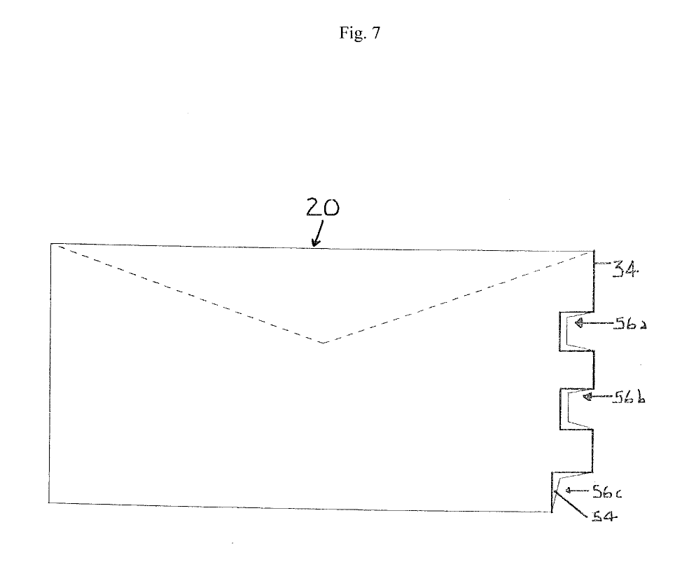

FIG. 7 is a frontal view of another embodiment of the container. In this embodiment, multiple fenestrations 56a, 56b and 56c appear along right side edge 34 of envelope 20 and right lower corner 42 (not shown here but shown in FIG. 1). The front side of rear surface of envelope 54 is visible. The fenestrations are rectangular in appearance. However, the shape, size, type, number, appearance, location, etc. of the fenestrations can be varied based upon the application or applications of a particular container.

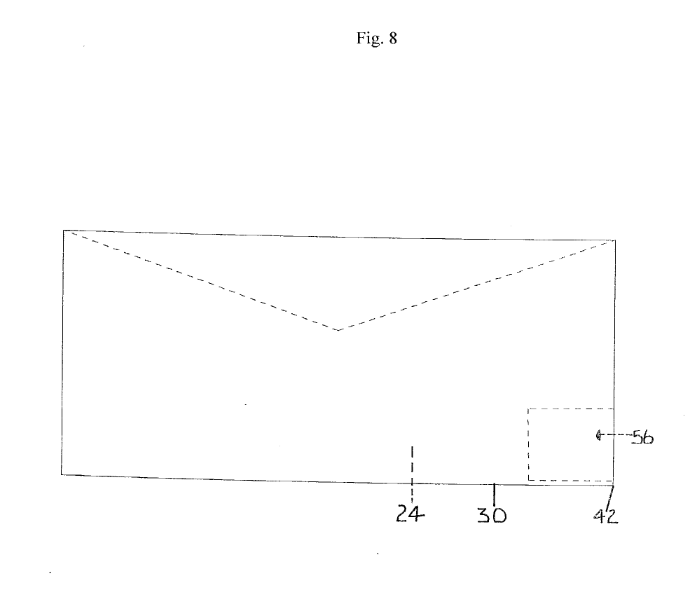

FIG. 8 is a frontal view of another embodiment of the container. Fenestration 56 involves the right side edge 34 and the rear surface 24, but neither lower edge 30 nor lower right corner 42.

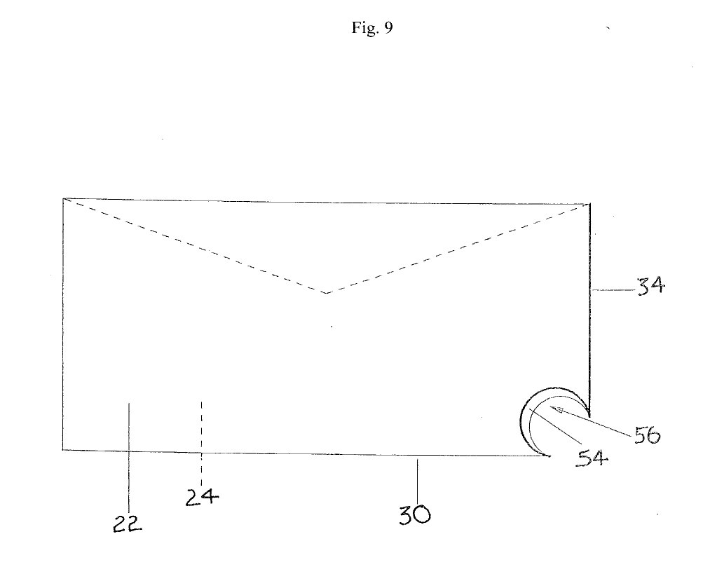

FIG. 9 is a frontal view of another embodiment of the container. Fenestration 56 is curved. It involves right side edge 34, front and rear surfaces 22 and 24 respectively, lower edge 30 and right lower corner 42 (not shown here but shown in FIG. 1). The front side of rear surface of envelope 54 is visible.

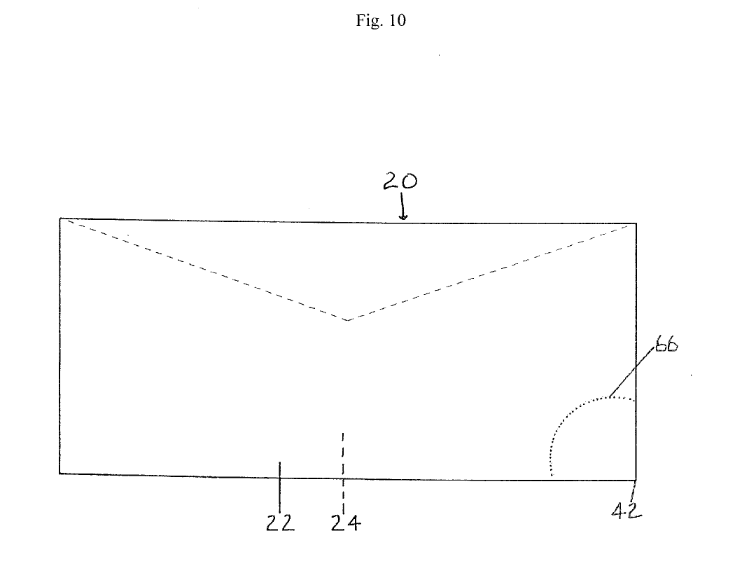

FIG. 10 is a frontal view of another embodiment of the container. A perforation 66 is present on the corresponding portions of the front surface 22 and rear surface 24 so as to facilitate removal of right lower corner 42 and create a fenestration. Although not demonstrated in FIG. 10, an embodiment in which a covered fenestration and/or covered fenestrations is/are exposed when an envelope is separated along a perforation and/or perforations is/are anticipated.

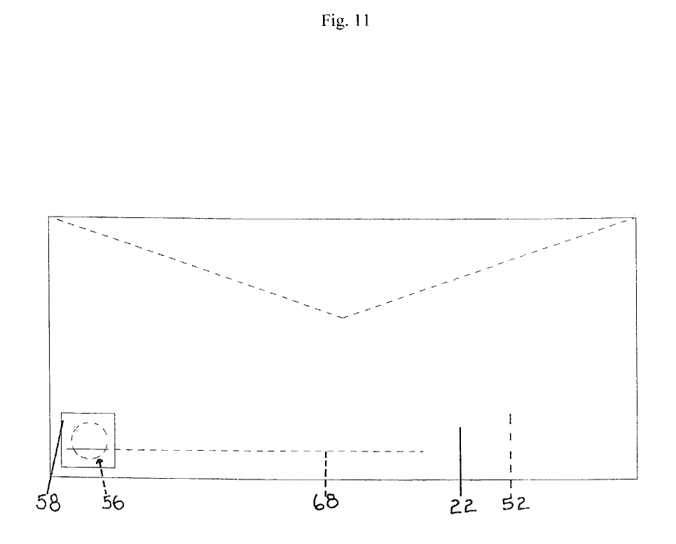

FIG. 11 is a frontal view of another embodiment of the container. Cover 58 covers fenestration 56. Cover 58 is applied to front surface 22. There is a security and/or tamper-proofing device represented by a thread 68. A portion of thread 68 is applied to the back side of front surface of envelope 52 until it reaches the right side margin of fenestration 56. As it continues to the left, thread 68 adheres to cover 58 and to the left of the left margin of fenestration 56, thread 68 is located between cover 58 and front surface 22.

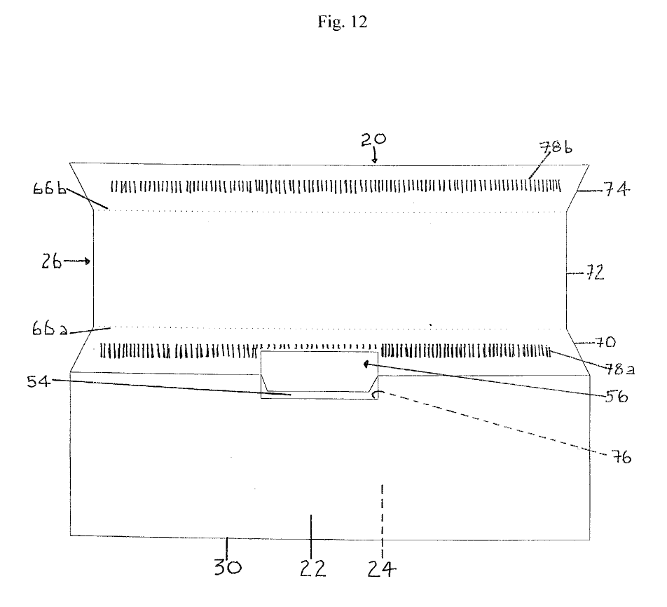

FIG. 12 is a frontal view of another embodiment of the container. FIG. 12 shows a representative remailer. Shown are front surface 22, the front side of rear surface of envelope 54, and flap 26 comprising three portions: a lower portion of flap 70 continuous with rear surface 24, a middle portion of flap 72 continuous with lower portion of flap 70, and an upper portion of flap 74 continuous with middle portion of flap 72. In this embodiment, lower portion of flap 70 has an adhesive material 78a applied to it. In this embodiment, there is adhesive material 78b applied to upper portion of flap 74. Fenestration 56 comprises a portion of rear surface 24, the corresponding portion of front surface 22 and a part of lower portion of flap 70. Space 76 can be seen. A perforation 66a is between lower portion of flap 70 and middle portion of flap 72. A perforation 66b is between middle portion of flap 72 and upper portion of flap 74.

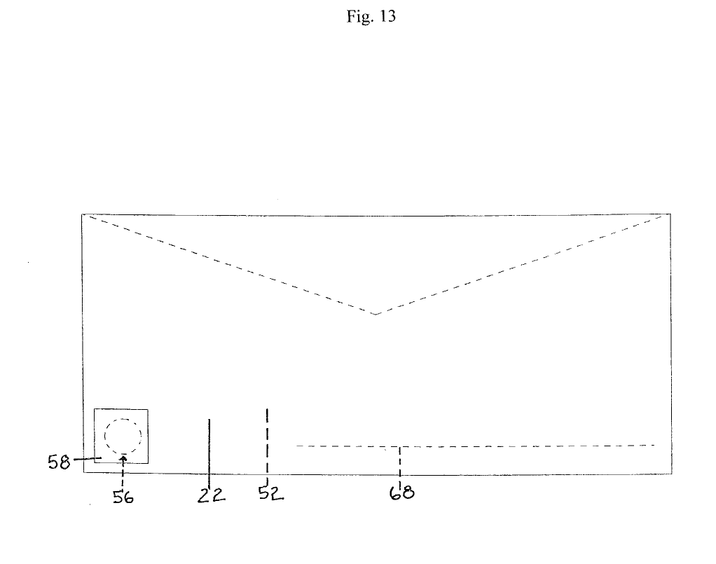

FIG. 13 is a frontal view of another embodiment of the container. Cover 58 covers fenestration 56. Cover 58 is applied to front surface 22. There is a machine readable and/or anti-counterfeiting device represented by a metal thread 68. Metal thread 68 is applied to the back side of front surface of envelope 52.

Advantages

From the description above, a number of advantages of my counter-terror envelope become evident:

1. Escape—some or all of the intentionally placed objectionable materials in the envelope can exit through the aperture(s) before causing any harm.

2. Mitigation—if not all of the intentionally placed objectionable materials escape, that which remains is lessened to the point of harmlessness.

3. Visualization—substances that have escaped from the envelope through the fenestration(s) and are in the covering(s), the contents, and/or insides of the envelope can be visualized prior to opening.

4. Testing—the insides of the envelopes, its contents, and/or the substances that have collected in the covering(s) can be tested either directly through the fenestration(s), covering(s), and/or by reactants incorporated into covering(s).

5. Sabotaging—sabotage is easily recognized by the handlers and/or recipient cautioning them to the possibility of a problem within prior to opening it.

6. Tampering—tampering is easily recognized by the handlers and/or recipient cautioning them to the possibility of a problem within prior to opening it.

7. Ease of Use—the method of use of the counter-terror envelope is familiar.

8. Warning—the counter-terror envelope is capable of warning those who handle and/or receive it as to the possibility of a hazard within prior to opening the container. Terrorists, troublemakers, pranksters, and/or hoaxers are warned to give up their mischief since it will not work.

9. Deterring—terrorists, troublemakers, pranksters, and/or hoaxers are deterred from committing their mischief since it will not work.

10. Handling—if special handling is desired due to the increased safety conferred through the use of my counter-terror envelope, distinguishing features for machine readability and/or manual recognition can be incorporated.

11. Alerting—no other envelope provides an opportunity for its handlers or recipient to alert the authorities as to a potential hazard within prior to opening it.

12. Preventing—the harmful escape and subsequent exposure to objectionable materials are prevented prior to opening the envelope.

13. Modifying—modification will occur to the behavior of the public, e.g., restoring trust in the mails; businesses, e.g., improving responses from direct mailings; terrorists and other troublemakers, e.g., by forcing them to use means other than envelopes to deliver their mischief.

14. Manufacturing—the counter-terror envelope is easy to manufacture. Only minor modifications to current equipment and/or processes are necessary. If desired, modifications to currently available envelopes could be made. A method of this would be through the use of hole punches, punch presses, etc. located at post offices whereby persons could fenestrate their old-style, non-counter-terror envelope(s) prior to sending.

15. Conformity—my counter-terror envelope can be made to conform to all existing and likely postal regulations. Reinforcement of the fenestrations can be used if increased strength of the envelope is necessary for machine handling.

16. Numerosity/Redundancy—Currently, the polls suggest, there are large numbers of people who are afraid to open the mail and are uncertain what to do about it. The counter-terror envelope allows the public at large to participate in detecting the presence of objectionable materials within envelopes. Not only does this increase the number of persons actively working towards safety, it also provides a back-up through the participation of the public, to the efforts of the postal service, government, and/or others trying to prevent terror.

17. Fail-safe—if the “high-tech” and other measures fail or are successfully avoided, the counter-terror envelope acts as a fail-safe to guard the health, safety and wellbeing of the public, the employees of the mail services, etc.

18. Confidence Building—once the threat of surreptitious attack is removed, the public, businesses, government, foreign agencies, foreign businesses, foreign governments, foreign nationals, etc. can regain confidence in the safety of the mails when the counter-terror envelope is used.

19. Limiting—the options available to terrorists, pranksters, hoaxers, troublemakers, etc. are limited as the use of envelopes and the mails is removed from their armamentarium.

20. Protecting—the counter-terror envelope extends protection beyond the handlers and/or recipients of envelopes to include those in relative proximity to the envelope as it is transported.

21. Expandable/Upgradeable—the counter-terror envelope is a unique container capable of functioning in any or all of the capacities described above and more. For example as technological advances in chemical detection of disease causing agents occur, they can be applied for use in the envelope as can advances in communications technologies which may make it possible for the counter-terror envelope to warn of danger or potential danger via the use of a transmitter.

Operation—FIG. 2—Preferred Embodiment

Fenestration 56 allows passage of contents from space 76 to the outside. Additionally, fenestration 56 allows access for visual and/or other evaluation(s) of space 76, back side of front surface of envelope 52, front side of rear surface of envelope 54, and any contents within space 76.

The operation and manner of using the invention are simple.

To send material, the manner of using the counter-terror envelope is identical to the use of present day envelopes. Namely, one inserts the intended contents into space 76. Then one closes envelope 20 using one's preferred means of closure. In this embodiment, flap 26 is used as the method of closure.

Substances smaller than fenestration 56, for example anthrax spores, would fall out at the time the contents were originally placed within space 76 and/or by gravity, centrifugal and/or other forces as envelope 20 and its contents are transported. The result is that substances smaller than fenestration 56 would fall out of envelope 20 prior to delivery.

Even if all the intentionally placed anthrax spores did not completely exit from envelope 20 through fenestration 56 during the delivery process, spillage through fenestration 56 would undoubtedly occur, reducing the remaining amount of anthrax spores to so little as to render it incapable of causing disease.

In the preferred embodiment, visual examination of space 76, inner surfaces 52-54, and/or the contents is accomplished by pressing upper edge 28 and lower edge 30 towards each other so as to expand fenestration 56. One would then look through fenestration 56 into envelope 20.

The same procedure as is used for visual examination can be used to easily determine if the counter-terror envelope has been sabotaged. Sealing fenestration 56 shut is a method of sabotage. This would prevent substances in space 76 that are smaller than fenestration 56 from passing to the outside. If by pressing the upper edge 28 and the lower edge 30 towards each other fenestration 56 fails to expand, there is a suspicion of sabotage. This would alert the mail handlers and/or recipient to a possible threat and afford him/her an opportunity to take precautions, alert authorities and prevent spread, in the case of anthrax, prior to opening envelope 20.

Fenestration 56 allows entry into space 76 for other methods of examination (e.g., mechanical, chemical, biological, etc.), the exact steps depending upon the nature of the examination to be performed.

Operation of the invention would be similar for a fenestration or fenestrations in other locations.

FIG. 3—Additional Embodiment

The operation and manner of using the invention are simple.

Substances smaller than fenestration 56 would fall into cover 58 at the time the contents were originally placed within space 76 and/or either by gravity, centrifugal and/or other forces as envelope 20 and its contents are transported. During the delivery process and/or at the time of delivery, the handlers and/or recipient could position the envelope such that fenestration 56 is dependent. Gravity would make substances smaller than fenestration 56, such as anthrax spores, fall through fenestration 56 into cover 58, allowing detection.

When transparent or sufficiently translucent, cover 58 allows for the visual inspection of space 76, inner surfaces 52-54, the contents remaining within envelope 20 but not in cover 58, and/or material(s) that have accumulated within cover 58.

In this embodiment, visual examination through cover 58 of space 76, inner surfaces 52-54, and/or the contents within space 76 is accomplished by pressing upper edge 28 and lower edge 30 towards each other so as to expand fenestration 56 and cover 58. One would then look through cover 58 and fenestration 56 into envelope 20. The same maneuver as described above can also facilitate the passage of substances smaller than fenestration 56 into cover 58 for visual or other detection.

Breaching fenestration cover 58, such as by piercing, tearing, etc. allows entry into space 76 for other methods of examination (e.g., mechanical, chemical, biological, etc.) the exact steps being dependent upon the nature of the examination to be performed.

The same procedure as is used for visual examination can be used to determine if envelope 20 has been sabotaged. Sealing shut fenestration 56 and/or cover 58 is/are forms of sabotage. Either or both would render fenestration 56 incapable of allowing the contents in space 76 that are smaller than fenestration 56 to pass into cover 58. If by pressing upper edge 28 and lower edge 30 towards each other fenestration 56 and/or cover 58 fail(s) to expand, there is a suspicion of sabotage. This would alert the handlers and/or recipient to a possible threat and afford him/her an opportunity to take precautions, alert authorities and prevent spread, in the case of anthrax, prior to opening the envelope. Similarly, a puncture, punctures, tears, rips, etc. in cover 58 would alert the handlers and/or recipient as to the possibility of sabotage.

Cover 58 may be used to test, characterize and/or identify the contents of envelope 20. For example, a cover containing a substance, such as antibodies that react in the presence of anthrax antigens, may change color or another of its initial physical or other qualities alerting the handlers and/or recipient to a danger within.

Also, cover 58 may be used to test the environment to which envelope 20 has been subjected. For example, a cover containing a substance, such as antibodies that react in the presence of anthrax antigens, may change color or another of its initial physical or other qualities when placed in a mailbox into which anthrax spores have been introduced, thus alerting the mail handler to a threat and affording him/her an opportunity to take precautions, alert authorities and prevent further spread.

Operation of the invention would be similar for a covered fenestration or covered fenestrations in other locations. If more than one covered fenestration is present on a particular container, each cover may not have the same function(s) as another.

FIG. 4—Additional Embodiment

To increase the structural integrity of fenestration 56, it is reinforced by reinforcement 60. This feature may be especially useful in the automated handling of the counter-terror envelope. A reinforcement may serve to protect the envelope from such things as tearing, folding, bending, etc.

A reinforcement need not only provide support. For example, a reinforcement containing substances, such as antibodies that react in the presence of anthrax antigens, may change color or another of its initial physical or other qualities alerting the handlers or recipient to a danger within an envelope or outside an envelope.

FIGS. 5-13—Alternative Embodiments

In FIG. 5 and FIG. 8, the fenestration or fenestrations involve only one surface of the envelope. In these embodiments, the envelope may have greater intrinsic support and may also provide greater support to the contents. Another manifestation that might also offer greater support to the contents and/or envelope is seen in FIG. 6 where fenestration 56 comprises both surfaces, but no edges or corners are involved. Yet another manifestation that may offer greater support is seen in FIG. 7, where-several smaller fenestrations 56a, 56b and 56c are present. FIG. 9 is another representation of where a fenestration or fenestrations can be located. In FIG. 9, only the right lower corner 42 (not shown here but shown in FIG. 1) is fenestrated. In this representation, the majority of the envelope 20 remains intact. FIG. 9 also demonstrates another possible shape of a fenestration. In FIG. 9 fenestration 56 is round.

FIG. 10 displays perforation 66 by right lower corner 42 of envelope 20. When separated along perforation 66, the larger moiety becomes a counter-terror envelope. The size, shape, location, number, purpose, type, etc. of perforation(s) and the size, shape, location, number, type, purpose, etc. of the resulting fenestration(s) following the separation(s) would be determined based upon various considerations (e.g., manufacturing, cost, handling, function, etc.). Either a covered or uncovered fenestration can appear following separation at a perforation.

In another form, a fenestration or fenestrations may comprise an appropriately sized opening but include a transparent or semi-transparent material through which the contents, the inside of the envelope and any substances that are in the covering can be easily viewed. The transparent cover 58, shown in FIG. 11 for example, may be chosen so that only selected portions of its surface are transparent, thereby permitting some of the contents to be seen through the window, but maintaining other parts of the contents covered so as to ensure privacy, as appropriate.

FIG. 11 also demonstrates a representative security and/or tamper-proofing device. If cover 58 is lifted from front side 22, a tear will appear in front side 22 as thread 68 is pulled. Other security and/or tamper-proofing mechanisms such as, holograms, perforations, etc. are possible.

In the embodiment shown in FIG. 12, to send contents, one inserts the contents into the space 76 and seals the envelope by activating, releasing, exposing, etc. adhesive 78b. This activation will depend on the nature of the process used to affix flap 26 and includes wetting, removing a protective strip to uncover adhesive, etc. Flap 26 is then folded over front surface 22 such that perforation 66b reaches lower edge 30 and folds over lower edge 30 to adhere to rear surface 24. Envelope 20 is opened by cutting, tearing, etc. along perforation 66b and unfolding flap 26. To return the envelope, it is cut, torn, etc. along perforation 66a removing middle portion of flap 72. The appropriate process for the particular envelope activates, releases, exposes, etc. adhesive 78a, applied to lower portion of flap 70. Affixing lower portion of flap 70 to front surface 22 seals envelope 20. In both directions, send and resend, the same fenestration 56 is present.

FIG. 13 is an embodiment of my invention for machine readability and/or anti-counterfeiting purposes. A metal thread 68 is present applied to the back side of front surface of envelope 52. Metal thread 68 can be detected by machine for purposes of special handling, identification, authenticity, etc. The metal thread is not limited to this manifestation, it can be included as a component of the envelope by being woven into it, applied to the rear surface, etc. Although in this embodiment metal thread 68 represents a machine readable and/or anti-counterfeit device, other strategies and manifestations are possible, such as, magnetic strip, printed circuit, sensory cues for human detection, etc.

The transparent, translucent, opaque, and/or complex fenestration cover(s) may also incorporate other features and characteristics that would enhance functionality, machine readability and/or detection, and permit appropriate security. Such characteristics may include reactive chemicals incorporated into or applied onto the covering to test for certain substances either inside of and/or outside of the envelope. Machine readability and/or detection can be enhanced through the inclusion of, for example, an optical marking or printed circuit to verify, for example, authenticity. A tamper-proofing or other security measure can be part of the envelope, reinforcement and/or the covering. For example, if a covering designed to test for anthrax has been removed, a tear, marking or other indication of such removal could become apparent. Certain security measures may include the provision of watermarks, color tinting, holograms or tamper-proofing means on the covering of the fenestration and/or on the surface(s), corner(s), closure(s) and/or edge(s) of the envelope.

The fenestration cover(s) is preferably secured to the inside of the envelope, although in certain embodiments it may be secured to the outside or both to the inside and outside thereof. The window covering may be a semi-transparent material such as glassine paper, as is customary or a transparent material, examples of which are Cellophane.RTM. or Mylar.RTM., or an opaque material, such as foil or ink.

In any of the embodiments, the covering(s) of the fenestration(s), or indeed the entire envelope, may be fabricated of transparent or semi-transparent material that may have its transmissivity reduced. This may be achieved by mechanical means or imprinting with a substance. Where mechanical, the transmissivity is reduced by distortion of the surface, for example, by hot or cold stamping, and ablation by electric discharge or abrasive blasting. Alternatively, transmissivity may be reduced by chemical processes of the material, and this may comprise a direct application of the chemical substance on the window, or indirect alteration of the chemical structure of the material by exposure to radiation including infra-red, ultra-violet and nuclear radiation or a combination thereof. Reduced transmissivity may comprise all or a portion of the envelope.

The cover(s) or envelope surface(s), edge(s), closure(s) and/or corner(s) may include a watermark, and this may incorporate security means to reduce the likelihood of copying or counterfeiting the envelope and/or covering over a fenestration. The watermark may be in the form of a hologram, or impressed by mechanical means. Chemical or photographic processes may also be used. Furthermore, the watermark or other security means may incorporate encoded information to be machine read, and this information may identify the manufacturer, or provide other relevant data.

One or a plurality of security measures can be incorporated into the envelope, cover(s), reinforcement(s), etc. For example, a magnetic strip, a metal thread and hologram can all be present for purposes of deterring such things as counterfeiting, tampering, etc. Another form of security is one that provides historical information about the envelope. For example, if radiation sterilization of mail is used, radiation sensitive materials present in the envelope, cover(s), reinforcement(s), etc. can become apparent following exposure confirming that the envelope was exposed.

One or a plurality of machine readable features may also be present in a particular envelope so as to permit multiple or sequential functions. Examples of these would include automated determination of test results from fenestration cover(s), mail routing, etc.

Remailer, return mail kits, response kits, etc. are of several formats depending upon the nature of the contents, conditions of use, etc. The anti-terror features of my invention can be used to improve existing formats or create new ones. The same or different fenestrations can be used for one, both or more directions. One or a plurality of fenestrations can be present in a particular envelope. Covered or uncovered fenestration(s) can be present. A combination of covered and uncovered fenestrations can be present in a particular envelope. Covered fenestrations having the same or different functions can be present.

Conclusions, Ramifications, and Scope

Accordingly the reader will see that the container of the invention provides a highly reliable, economical, easily manufactured, simple to use solution to deter or prevent the use of envelopes as a way of delivering pranks, hoaxes, harm, injury, illness, hazard, disruption, destruction, and/or death.

Although the above description contains many specificities, these should not be construed as limiting the scope of the invention, but merely as providing illustrations of some of the presently preferred embodiments of this invention. For example, the fenestrations can be of other shapes, such as circular, oval, triangular, etc.; the fenestrations can be of other sizes, such as larger, smaller, slit, slit-like, pinhole, etc.; the fenestrations can be in other locations, such as involving the closure, the right upper corner, etc.; the fenestrations can be different in number, fewer, more, multiple, etc.; a particular envelope can comprise one covered fenestration or a plurality of covered fenestrations; any particular cover can have one or a plurality of light transmission characteristics, such as transparent, translucent, semi-transparent, opaque, complex, etc.; when more than one cover is present, each cover can function the same as another cover, function similar to another cover, function differently from another cover, etc.; when more than one cover is present, each cover can have light transmission characteristics the same as another cover, light transmission characteristics similar to another cover, light transmission characteristics different from another cover, etc.; my invention can use different security and tamper-proofing methods, schemes, strategies, mechanisms, etc.; the closure mechanism can be via clasp, adhesive, attractive force, fixative, etc.; the fenestrations can be present in a container ht is not flat, such as within the pleats of an expandable container, etc.

Although the example of a mailing envelope was used in the preferred embodiment, other types of envelopes, such as, remailer, return mail kit, response kit, reply kit, packet, pleated envelope, etc. are anticipated.

Although the example of a fenestration was used in the preferred embodiment, other types of exit means are anticipated.

For remailer and other return mail schemes, the fenestration(s) can appear in any other location and can be in different locations for the different legs of the trip. As with the other embodiments, covered, uncovered and/or a combination of covered ad uncovered fenestrations is possible. Also possible are the other variations mentioned above, such as those in purpose, shape, size, type, number, appearance, location, etc. The unique features of this invention can be incorporated into other forms of remailer, return mail kits, response kits, etc.

Formats for machine readability will vary depending on a number of considerations, such as purpose, equipment, cost, etc. In addition to metal threads, other formats are possible, such as magnetic strip, printed circuit, optical characters, etc. One or a plurality of machine readable features can be incorporated into a particular envelope.

Formats for anti-counterfeiting purposes will vary depending on a number of considerations, such as purpose, equipment, cost, etc. In addition to watermarks, other formats are possible, such as magnetic strip, printed circuit, optical characters, etc. One or a plurality of anti-counterfeiting features can be incorporated into a particular envelope.

Formats for tamper-proofing will vary depending on a number of considerations, such as purpose, equipment, cost, etc. In addition to threads, other formats are possible, such as perforations, watermarks, holograms, etc. One or a plurality of tamper-proofing features can be incorporated into a particular envelope.

The current invention allows for two broad categories of testing the interior and/or contents of the container. One is through the fenestration(s); the other is via the covering(s) over the fenestration(s). For either category, coding by color, shape, material, bordering, decoration, pattern or other sensory cue may facilitate recognition, a testing purpose, etc. For testing functions comprised by the coverings, tests for different reactions (different from the anthrax example provided above) are anticipated. It need not be that the reaction providing a test result creates a visual cue as to the nature of that result. It is anticipated that over time, other sensory cues (e.g., audible) and even alerting a remote location to the presence of a particular condition, substance, substances, etc. will occur as these reactive materials and warning systems develop.

It is however not necessary to limit testing to the interior or contents of the envelope. Once a reactive substance has been placed in a cover over a fenestration, or elsewhere on or in the envelope, there is no reason why the exterior cannot be used for testing as well. Using anthrax as an example, if a terrorist or troublemaker stymied by the current invention chooses to dump his or her anthrax into a mailbox, a reaction to the anthrax antigens may take place on the surface of the coverings or elsewhere on or in the envelope thus alerting the mail carrier to its presence within that mailbox.

The testing function of this invention anticipates its use in settings other than terror. For example, industrial or medical diagnostic testing or other types of identification, characterization or evaluation may be performed on the contents of the envelope by the components of the envelope or through processing of the envelope while the contents are within or after the contents have been removed from the envelope. Remote testing facilities would benefit greatly from this.

An embodiment containing some type of mark or detectable feature is anticipated. The U.S. Postal Service and/or other agencies, foreign mail services, domestic businesses, foreign businesses, couriered mail services, etc. may determine that the counter-terror envelope has significant value in deterring and/or preventing an attack. If so, it may be decided that materials mailed in envelopes according to my invention will be provided either preferential treatment or less intense interrogation. If that were the case, then a mechanism for the invention to identify itself (e.g., a marking, printed circuit, machine-readable glyph, etc.) to some type of automated sorting machine or manual sorter would be an advantage and is therefore anticipated. The nature of this mark or detectable feature should subordinate itself to the preferred scheme as determined by the entities choosing to employ such a scheme. Possibilities include watermarking, holograms, magnetic strips, encoded data, microchip, etc.

Thus the scope of the invention should be determined by the appended claims and their legal equivalents, rather than by the examples given.

I claim:

1. A method for preventing the successful delivery of some or all contents placed within a delivery container, comprising the steps of,
a. providing said delivery container, and
b. providing said delivery container with an exit means for some or all of said contents to depart said delivery container, and
c. placing said contents within said delivery container having said exit means, and
d. exiting of some or all of said contents outside of said delivery container through said exit means,
whereby some or all of said contents have exited said delivery container prior to delivery.

2. A method as in claim 1 wherein said contents were placed with intent to deliver.

3. A method as in claim 1 wherein material or materials having a means for identifying predetermined contents of said delivery container covers or cover a predetermined portion of said exit means.

4. A method as in claim 1 wherein said exit means comprise one or more fenestrations within said delivery container.

5. A method as in claim 1 wherein said delivery container is an envelope.

6. A method as in claim 1, wherein said contents comprise hazardous, harmful, injurious, disruptive, terror-causing, disease-causing, destructive and/or deadly materials.

7. A method as in claim 4 wherein said delivery container is an envelope.

8. A delivery container that prevents the successful delivery of all or some of its contents, comprising:
a. a delivery container and
b. an exit means in said delivery container whereby all or some of said contents can exit prior to delivery.

9. A delivery container as in claim 8 wherein said contents were placed with intent to deliver.

10. A delivery container as in claim 8 wherein material or materials having a means for identifying predetermined contents of said delivery container covers or cover a predetermined portion of said exit means.

11. A delivery container as in claim 8, wherein said exit means comprise one or more fenestrations within said delivery container.

12. A delivery container as in claim 8, wherein said contents comprise hazardous, harmful, injurious, disruptive, terror-causing, disease-causing, destructive and/or deadly materials.

13. A delivery container as in claim 8, wherein said delivery container is an envelope.

14. A delivery container as in claim 11 wherein said delivery container is an envelope.

15. A method for preventing the successful delivery of some or all contents placed within an envelope, comprising providing an exit means for some or all of said contents to depart said envelope so as to allow some or all of said contents within said envelope to exit from said envelope prior to delivery.

16. A method as in claim 15 wherein said contents were placed with intent to deliver.

17. A method as in claim 15 wherein material or materials having a means for identifying predetermined contents of said envelope covers or cover a predetermined portion of said exit means.

18. A method as in claim 15, wherein said exit means comprise one or more fenestrations within said envelope.

19. A method as in claim 15, wherein said contents comprise hazardous, harmful, injurious, disruptive, terror-causing, disease-causing, destructive and/or deadly materials.
